(19) United States
(12) Patent Application Publication
(10) Pub. No.: US 2026/0162136 A1
(43) Pub. Date: Jun. 11, 2026

(54) SYSTEMS AND METHODS FOR EXTRACTING CASH MARKET COMMODITY PRICES FROM UNSTRUCTURED DATA, INFERRING MISSING PRICES, AND OPTIMIZING THE SUPPLY CHAIN BASED ON THE ASSEMBLED STRUCTURED DATA SET

(71) Applicant: CONTANGO, INC, Lafayette, IN (US)

(72) Inventors: Benjamin Brame, West Lafayette, IN (US); Daniel Lee Whitenack, West Lafayette, IN (US)

(21) Appl. No.: 19/183,335

(22) Filed: Apr. 18, 2025

Related U.S. Application Data
(60) Provisional application No. 63/641,098, filed on May 1, 2024.

(51) Int. Cl. G06Q 30/0202; G06Q 10/04

(52) U.S. Cl. CPC G06Q 30/0202; G06Q 10/04

(57) ABSTRACT

A system include a plurality of hardware modules that comprise a structured data extraction module configured to generate normalized commodity data from electronic versions of commodity data hosted on one or more computing systems, a data inference module configured to generate missing data items in a structured data set using one or more trained inference models; and an application module configured to save the normalized data and generated missing data items in a data store as part of the structured data set, generate, in response to received user input, supply chain optimization data by inputting a relevant portion of the structured data set into a selected data processing sub-module, and transmit the supply chain optimization data to a client device for presentation on a graphical user interface thereof.

### RELATED APPLICATIONS

This application claims the benefit of U.S. Provisional Application No. 63/641098 (filed on May 1, 2024), which is incorporated in its entirety by reference herein.

### FIELD OF THE DISCLOSURE

The present disclosure generally relates to the assembly of datasets from unstructured, incomplete datasets on personal computers, mobile devices, and/or edge devices; and more particularly assembling price datasets for commodity supply chain optimization using a hybrid of generative AI methods for price extraction and machine learning and ai inference models to estimate missing data.

### BACKGROUND

Commodity supply chains are difficult to optimize because of challenges in assembling a complete set of prices. Commodity information such as bids, offers, inventory, or expected receipts are often unique to a location (or “market”) and change frequently. Traders must track prices for a large number of markets from which they buy or sell. Furthermore, traders must track transportation costs connecting each pair of markets. Often multiple transportation options exist between a pair of markets comprising multiple modes including truck, rail, barge, container, pipeline, vessel, etc. Access to most of this data exists in unstructured form such as on a website, in an email, in a chat message, in a phone transcript, in an SMS message, etc. Existing supply chain optimization solutions are ineffectual because they rely on a complete and normalized data set to optimize.

### BRIEF DESCRIPTION OF THE FIGURES

The Figures described below depict various aspects of the system and methods disclosed therein. It should be understood that each Figure depicts one embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 depicts an example computing environment 10 for extracting cash market commodity prices from unstructured data, inferring missing prices, and optimizing the supply chain based on the assembled structured data set, according to one embodiment.

FIG. 2 depicts an example server for the computing environment 10 of FIG. 1, according to one embodiment.

FIG. 3 depicts example market context data sources for the computing environment 10 of FIG. 1, according to one embodiment.

FIG. 4 depicts example commodity data sources for the computing environment 10 of FIG. 1, according to one embodiment.

FIG. 5 depicts example market context data sources for the computing environment 10 of FIG. 1, according to one embodiment.

FIG. 6 depicts an example computing environment 20 for extracting cash market commodity prices from unstructured data, inferring missing prices, and optimizing the supply chain based on the assembled structured data set, according to one embodiment.

FIG. 7 depicts an example computer implemented method for converting images into commodity information tables using the computing environments 10 or 20 of FIG. 1 or 6, according to one embodiment.

FIG. 8 depicts an example computer implemented method for converting text communications into commodity information tables using the computing environments 10 or 20 of FIG. 1 or 6, according to one embodiment.

FIG. 9 depicts an example computer implemented method for formatting commodity information into a commodity information table using the computing environments 10 or 20 of FIG. 1 or 6, according to one embodiment.

FIG. 10 depicts an example computer implemented method for inferring missing commodity bid data using the computing environments 10 or 20 of FIG. 1 or 6, according to one embodiment.

FIG. 11 depicts an example computer implemented method for choosing an optimal freight-logical market over time using the computing environments 10 or 20 of FIG. 1 or 6, according to one embodiment.

FIG. 12 depicts an example computer implemented method for choosing an optimal set of trades while respecting specified constraints using the computing environments 10 or 20 of FIG. 1 or 6, according to one embodiment.

FIG. 13 depicts an example computer implemented method for calculating implications of a projected future market change using the computing environments 10 or 20 of FIG. 1 or 6, according to one embodiment.

FIG. 14 depicts an example computer implemented method for querying structured commodity information using natural language queries using the computing environments 10 or 20 of FIG. 1 or 6, according to one embodiment.

FIGS. 15-34 depict example user interface displays for interacting with the computing environments 10 or 20 of FIG. 1 or 6, according to one embodiment.

The Figures depict preferred embodiments for purposes of illustration only. One skilled in the art will readily recognize from the following discussion that alternative embodiments of the systems and methods illustrated herein may be employed without departing from the principles described herein.

### DETAILED DESCRIPTION

### Overview

This disclosure describes systems and methods for assembling a structured data set of commodity supply chain data for both markets and transportation between them and optimizing the supply chain based on the resulting data set. Supply chain data includes but is not limited to bids, asks, offers, inventory, expected receipts, transportation costs, transportation throughput limits, etc. Such data is referred to generally as “commodity data”.

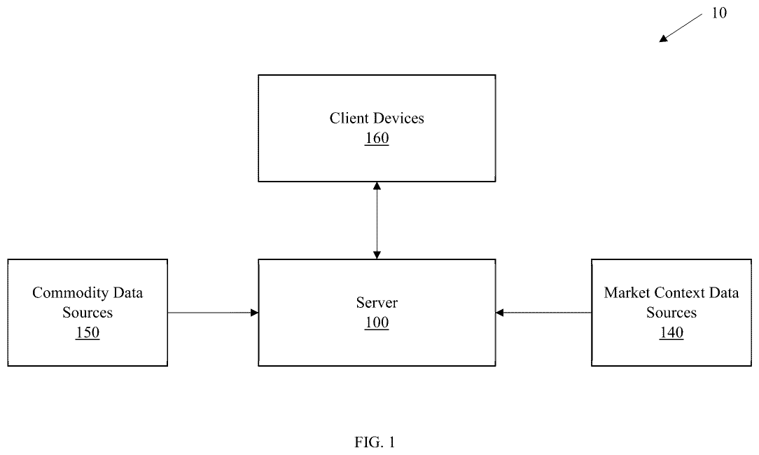

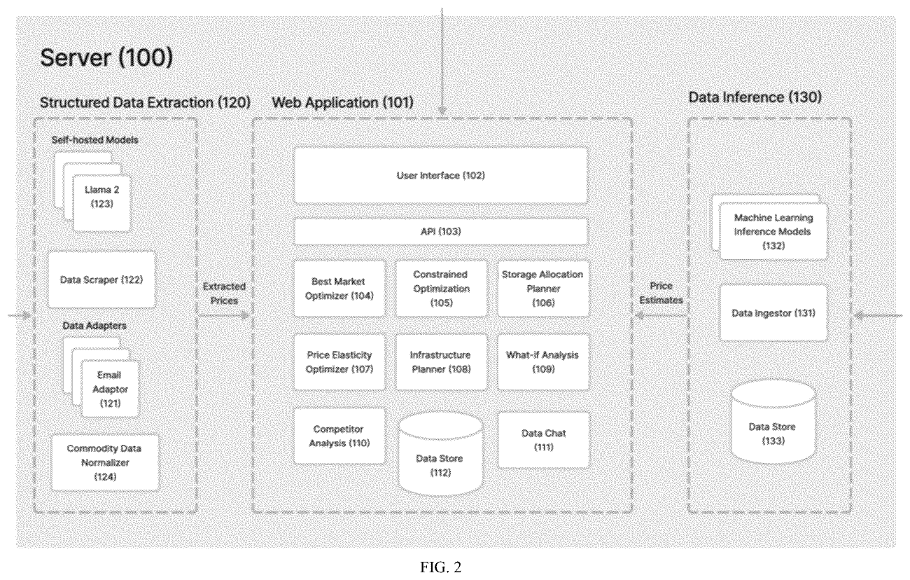

FIG. 1 shows a computing system (10) that includes a server (100) that electronically interfaces with market context data sources (140), commodity data sources (150), and client devices (160). In general, the server 100 includes one or more processors and one or more memories. The one or more processors can include various hardware processing components such as microprocessor, computer central processing unit (CPU), a field programmable gate array (FPGA), an application-specific integrated circuit (ASIC) etc. The one or more memories can include non-transitory tangible computer readable media such as read only memory (ROM), random access memory (RAM), etc. The one or more memories are configured to store computer-readable instructions, that when executed by one or more processors, cause one or more processors to perform various acts. For example, the machine readable instructions, when executed by the one or more processors, can form a plurality of hardware modules such as the web application module (101), a data extraction module (120), and a data inference module (130) shown in FIG. 2.

A hardware module may be implemented mechanically or electronically. For example, a hardware module may comprise dedicated circuitry or logic that is permanently configured (e.g., as a special-purpose processor, such as an FPGA or an ASIC to perform certain operations as described herein. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

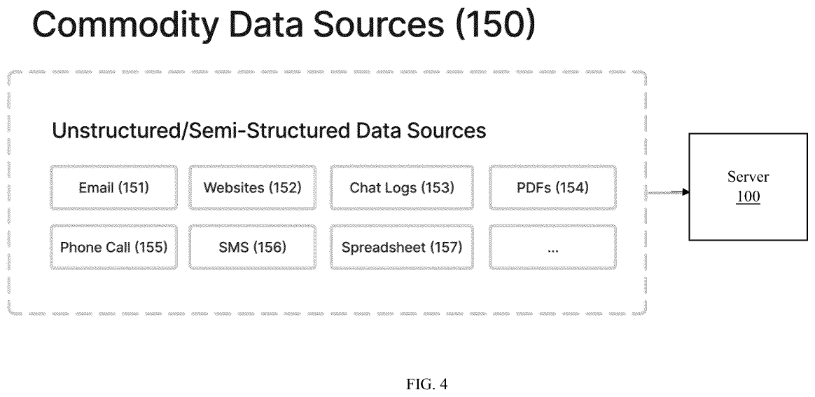

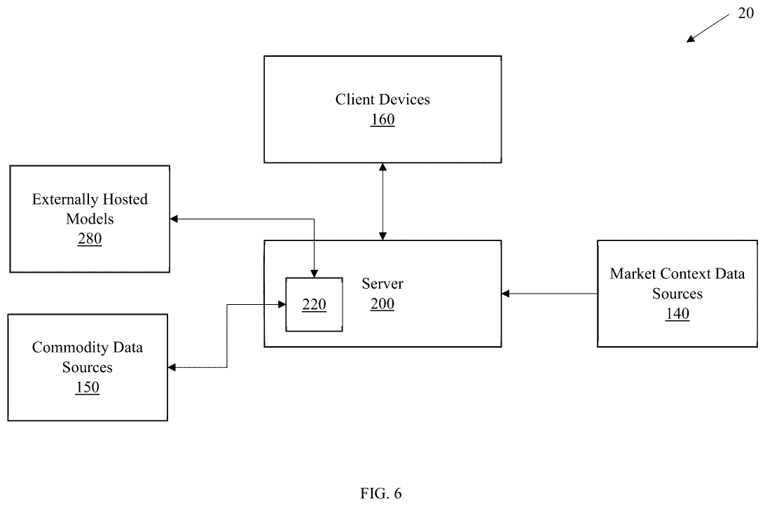

With reference to FIG. 2 and FIG. 4, it is shown that the data extraction module (120) connects with various unstructured commodity sources (150) such as email, phone transcripts, SMS messages, webpages, etc via a collection of data adapters (121). Examples of adaptors include Python code to capture screenshots of websites via Selenium and Python code to retrieve emails from a Gmail inbox. The output of the data adaptors is stored in (on disk or in RAM). Data scrapers (122) then read the output of the data adaptor and create semi-structured tables of prices or other commodity-related data. When the data is in an unknown format (such as a free-form email or phone transcript), large language models (123) are employed to extract semi-structured data from the unstructured text (for example a table of prices for a given set of locations and delivery windows). Note that as shown in FIG. 6 a computing system (20) can utilize a server (200) that is like the server (100) except that the server (200) includes a data extraction module (220) that interfaces with externally hosted models (280) in place of the self hosted models (123) used by the data extraction module (120).

With reference again to FIG. 2 and FIG. 4, the semi-structured data extracted from the commodity sources (150) (typically in a table format) is then normalized using the commodity data normalizer (124). The commodity data normalizer (124) interprets acronyms (e.g. JJA=>June 1 through August 31), enforces common formats (e.g. 40=>$0.40), and matches location mentions to a canonical list of physical locations (e.g. Ft. Wyn=>The NS Railyard in Fort Wayne Indiana). The result is a normalized list of commodity data such as prices or demand which can be cleanly imported into the Data Store (112) within the web application (101). It will be appreciated that the data extraction module (120) and the data extraction module (220) can run on the respective servers (100) or (200) or within a serverless infrastructure service such as Amazon Lambda.

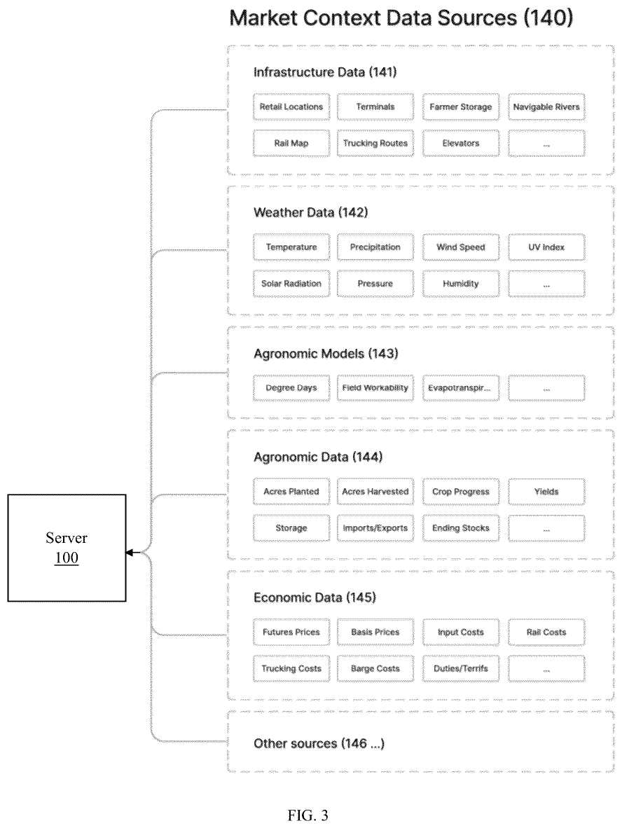

Often gaps exist in the data collected by the Data Extraction Modules (120), (220). In such cases, the missing values are estimated to assemble a complete picture of supply chain prices. In such cases, the Data Inference Module (130) estimates the missing values. The Data Ingestor (131) regularly captures public and private data sources which are correlated with the missing data to be estimated. In particular, the Data Inference Module (130) can interface with the Market context data sources (140) as shown in FIG. 3 to capture this public and private data. For example, missing cash for a given location and delivery period can be estimated using a bid's historical relationship to (A) neighboring bids (B) time of year (C) futures price (D) unharvested acres (E) bushels in storage. Such data is assembled into a common data store (133) as it is released. Relevant data sources are used to train inference models (132) which estimate commodity data when it is missing. These estimates are then stored in the Data Store (112) within the web application (101) with appropriate meta information about how the estimates were derived.

The web application (101) connects to the Data Store (112) in which a complete data set of commodity information is stored. The web application (101) includes data analysis sub modules that leverage this data set to inform key supply chain decisions.

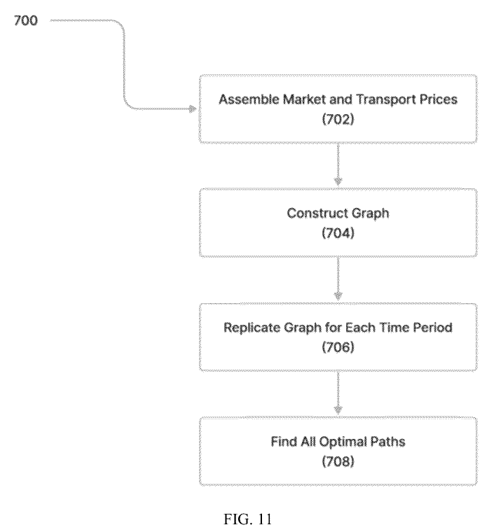

The Best market optimizer (104) identifies the best market to buy from or sell to in a freight-adjusted way. It receives as input a commodity and delivery window and identifies all valid bids for this period and commodity. It then estimates the best (cheapest, fastest, fastest below X price, cheapest before Y date), by factoring the transportation cost into the price. For dates in the future, carry is taken into account. For commodity positions that are hedged by a corresponding futures position, both the cost of carry and the roll yield is accounted for. When taken together, this method can be used to identify the best market and time period for that market for which the highest price for the commodity can be obtained. This is explained in more detail in the method shown in FIG. 11 as described below.

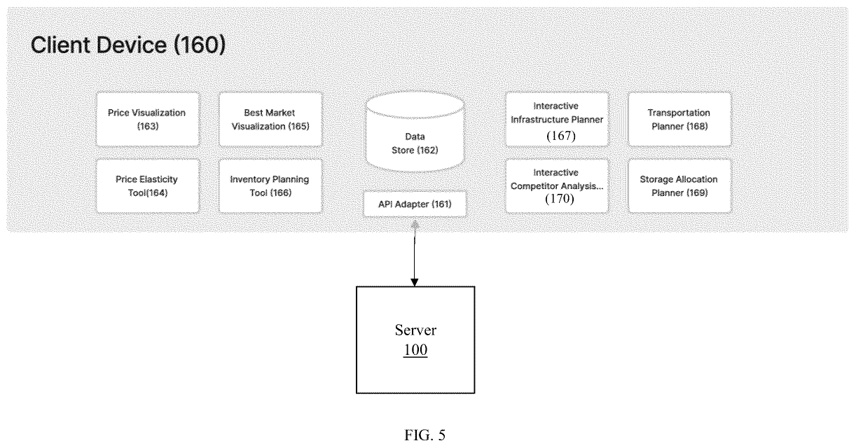

With reference to FIG. 5, the client device (160) interfaces with the Server (100) to transmit user inputs to the server (100) and receive data for storing in data store (162) or display on an graphical user interface of the client device (160). In particular, the display of information can be accomplished via the price visualization modules (163) and/or the best market visualization modules (165) in conjunction with one or more other hardware modules of the server (100). Furthermore, the price elasticity tool module (164), the inventory planning tool module (166), the interactive infrastructure planner module (167), the transportation planning module (168), the storage allocation planning module (169), and the interactive competitor analysis module (170) can provide user inputs to the server (100) for use with one or more of the data analysis sub modules of the web application (101).

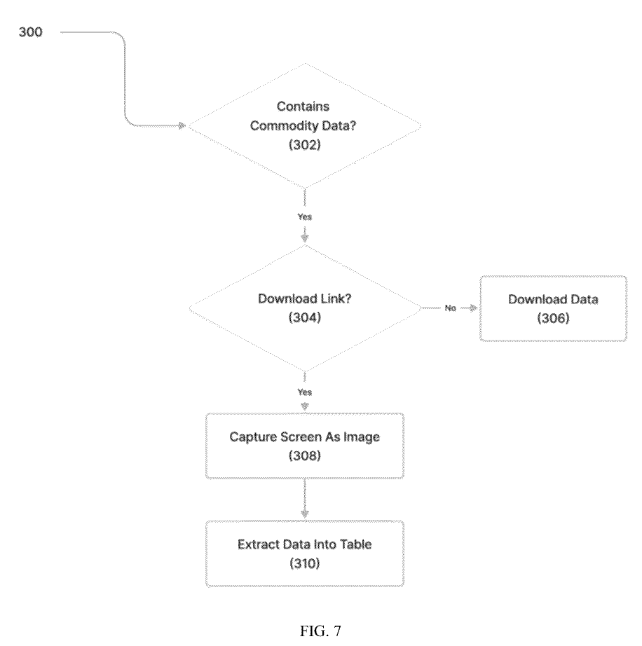

With reference now to FIG. 7, a method for converting images into commodity information tables using, for example, the structured data extraction modules (120) or (222) is shown. Commodity data such as prices are often posted publicly or behind a login on websites (300). The data from the websites (300) can be extracted in a structured form. The systems described herein first determine if the website is likely to contain commodity data (302). This check is performed before proceeding. This check can be performed using a curated list or determined on the fly using an agent-based approach which optionally calls a search functionality. Second, the systems described herein check to see if a download link or an application programing interface (API) call to pre-structured data is available (304). If those methods are available, the data is downloaded (306). Otherwise, the systems described herein take one or more screenshots from the site to capture an image of the commodity data (308). Multiple screenshots and scrolling may be used if the page is long or if there are separate pages for different locations, commodities, etc. For each screenshot, the system determines if a commodity table is present and its associated boundaries within the image. The system then extracts all such tables as images using the boundaries detected (310). Traditional table recognition, optical character recognition (OCR), and/or a multi-modal language model (e.g. GPT Vision or LLaVA) can be used to extract the tables.

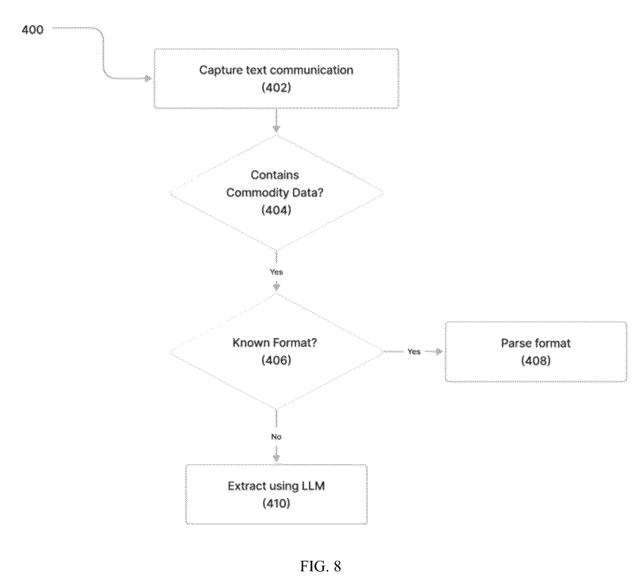

With reference now to FIG. 8, a method for converting text communications into commodity information tables using, for example, the structured data extraction modules (120) or (222) is shown. Text communication (including but not limited to emails, PDFs, SMS messages, chat logs, phone transcripts, etc) can be converted into structured text tables (400). The text data is first captured (using an email retrieval API, a chat API, a voice message API fed into a voice-to-text system, etc.) and stored (to memory, disk, etc) (402). The system then determines if the text data contains commodity information. This is achieved using a rule-based method, an LLM prompt, or some other statistical method (404). If commodity bid information is detected, the system determines if the commodity bid information is in a known commodity text format (406). If the bid information is in a known format, the information is parsed into a structured table using traditional rule-based methods familiar to anyone skilled in the art (408). Otherwise, the commodity information is extracted using one or more LLM-based, machine-learning, or statistical methods (410) (e.g., the internally hosted models (123) or externally hosted models (280) shown in FIGS. 2 and 6 may be employed).

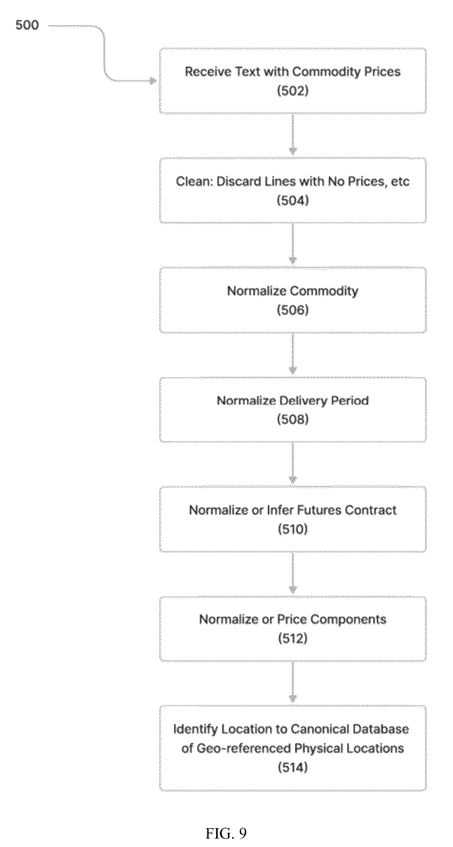

With reference now to FIG. 9, a method for refining text data (e.g., formatting commodity information into a commodity information table) using, for example, the structured data extraction modules (120) or (222) is shown. Commodity text tables can be refined into a structured, canonical format (502). Text information is first received from storage (in RAM, on disk, etc) (502). Each line is examined and lines without commodity information are discarded (504). The commodities referenced by the row are detected or inferred and then transformed to a standardized format. For example “beans” or “soy” might be present and transformed to the standardized “soybeans”. In some cases such as a soybean crush facility, the commodity may be implicit and detected through predefined rules (e.g. facility is labeled as a soybean facility, the prices listed imply soybeans, etc) or an LLM-based system capable of inferring it (506).

Furthermore, Commodity prices are often tied to a futures contract. In such cases, the correct futures contract is determined. The contract may be explicitly listed in various formats (e.g. December Corn, 2024, CZ24, December '24, etc) or it may be inferred from the basis month or the end of the delivery period (508). If a delivery period exists for the commodity bids or offers, this is extracted and normalized as well. The delivery period consists of a start and end date, and may be specified as a date range, a single end date, a month name, a month range (e.g., JJA for June, July, August), etc. In all cases, the delivery period is correctly extracted (510). Prices are also normalized to a standard format. A cash price often consists of (A) a futures price as measured at some data (e.g. previous day's closing price) added to (B) a spatial adjustment sometimes referred to as “the Basis”. When only the basis or the cash price is supplied, the others may be inferred by retrieving the associated futures price and adding it to the basis to determine the cash price or subtracting it from the cash price to determine the basis. Additionally, prices may be expressed in various formats or units (e.g. cents vs. dollars, various currencies, and various formats such as accounting format, with/without commas, and with/without currency symbols). These inconsistencies are rectified and the resulting cleaned price data is determined (512). Commodity prices are often associated with physical locations. The corresponding physical location from a canonical geo-database of physical locations are determined using a rules-based or LLM-enabled approach (514).

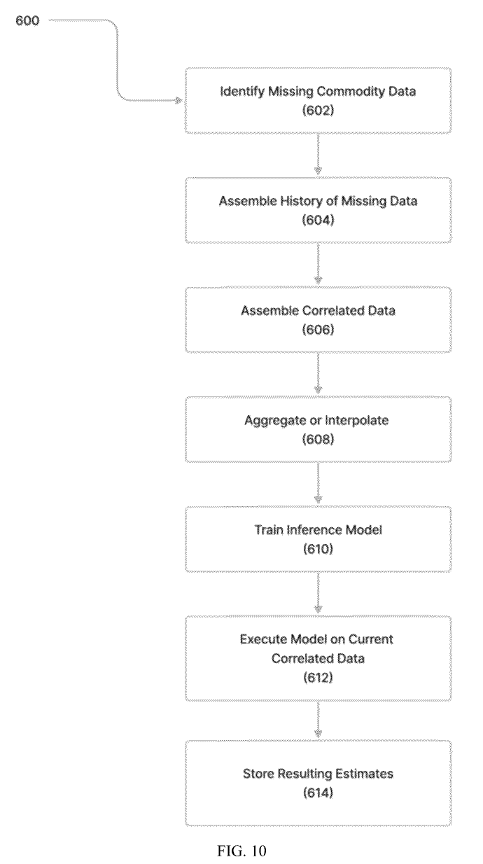

With reference now to FIG. 10, a method for generating or inferring missing commodity data using, for example, the data inference module (130) is shown. Missing commodity data can be detected and inferred (600). The missing data is first detected (602). Examples include cases where (A) no price data is published on a website or via email for a specific location (B) price data is published, but is omitted for a given delivery period, etc. In such cases, the missing data may be estimated by first assembling a history of the data to be estimated (604). For example, if December corn bids are missing at a given location, the history of corn bids at this location will be collected. Correlated data is also assembled (606). Market Context Data Sources (240) contains many examples of such data such as historical yields, acres planted or harvested, location-level cash or basis bids, futures prices, ending stocks, supply/demand, customer sentiment scores, relationships between locations and competitors, seasonality, etc. Correlated data may also include private customer data such as receipts, market share, rumored prices, etc.

The datasets are then assembled so that each historical record of the value to be estimated receives a corresponding data point for each correlated data. Correlated data is aggregated or interpolated so that it can be expressed in the same unit to be estimated (e.g. per-location-per-day, per-county-per-week, etc.) (608). An inference model such as a random forest is then trained on this assembled data in a way that predicts the historical target data based on the correlated data (610). The missing data is then estimated by first assembling current correlated data and then running the inference model on the current correlated data to produce an estimate (612). The resulting estimate is stored along with meta-data such as when it was estimated, the data on which it was based, etc (614). It will be appreciated that the training of the inference models can be done at a time separate and distinct from the time when the trained versions of the models are used to generate currently missing data items. In these embodiments, the systems can select a relevant previously trained inference model based on the type of the currently missing data items.

An illustrative example for applying the method shown in FIG. 10 to generate missing grain basis bids includes:
1. Identifying that several locations have not posted a grain basis bid for several timeframes in the future.
2. Assembling history of grain basis for each date and location.
3. Assembling correlated data such as neighboring bids (differential and distance from bid), the corresponding futures price, the structure of the futures market (contango vs. backwardation), the time of year, the crop progress (corn, soybean, and wheat planting progress, harvest progress, etc), the current year's yield estimate (from the USDA or a commercial source), the number of acres planted, the amount of grain in storage (USDA report), etc.
4. Aggregating all of this data to a per-grain-buyer-location basis. Some data is reported at the county, state, or national level. In such cases, use the value for the location's geographic region. Some values are reported more or less frequently than the basis values we are trying to predict. In such cases use aggregation for higher resolution data (e.g. futures) or interpolation for lower resolution data (e.g. acres reports). The result of this process will be a table where each row corresponds to a matching set of dependent and independent variables. Concretely each row will contain a basis bid as well as a corresponding value for the futures price, time of year, crop progress, planted acres, etc.
5. Training an initialized inference model (such as a random forest or support vector machine, etc) on this dataset to produce a trained inference model.
6. Estimating the missing bids identified in step 1 by first assembling current versions of the correlated data (from step 3). Specifically the current futures price, the neighboring bids, the time of year, the current crop progress, etc. are assembled and the trained inference model is used to infer the missing bids.
7. Storing the missing bids as generated by the trained inference model in the database along with metadata indicating when the model was executed, the dataset on which it was trained, and the fact that it is an estimate and not a measured value.

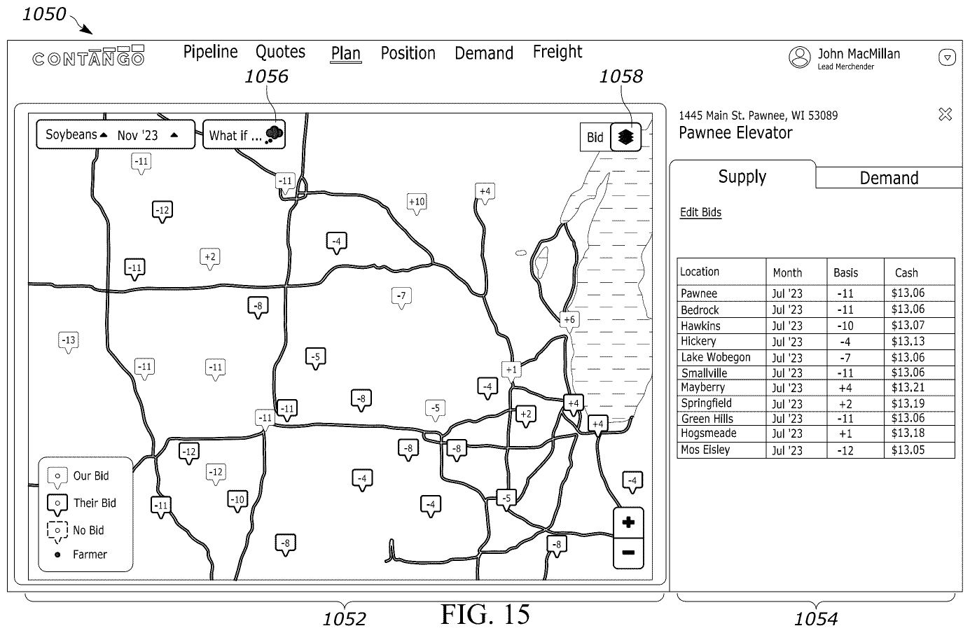

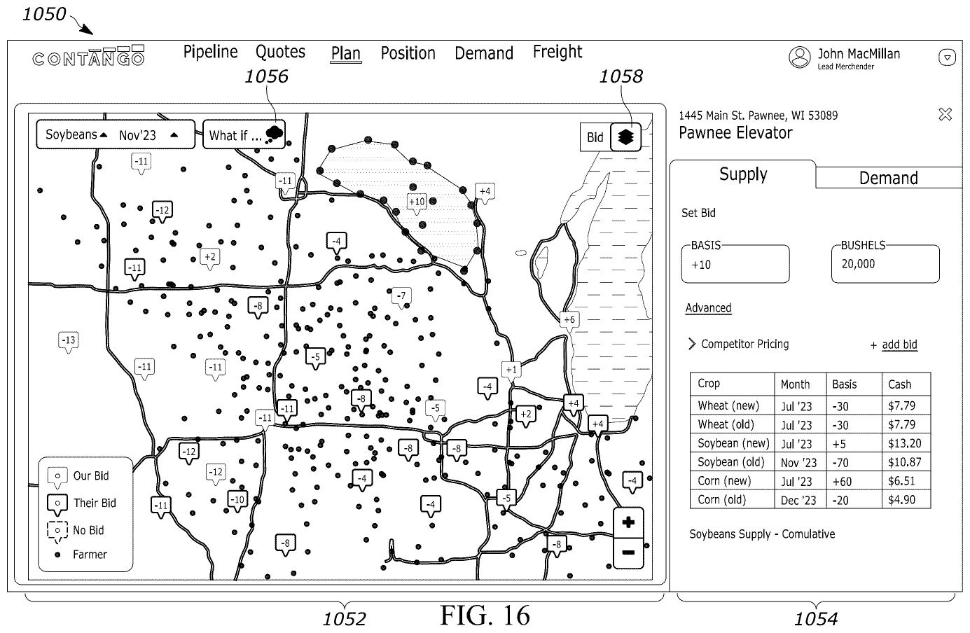

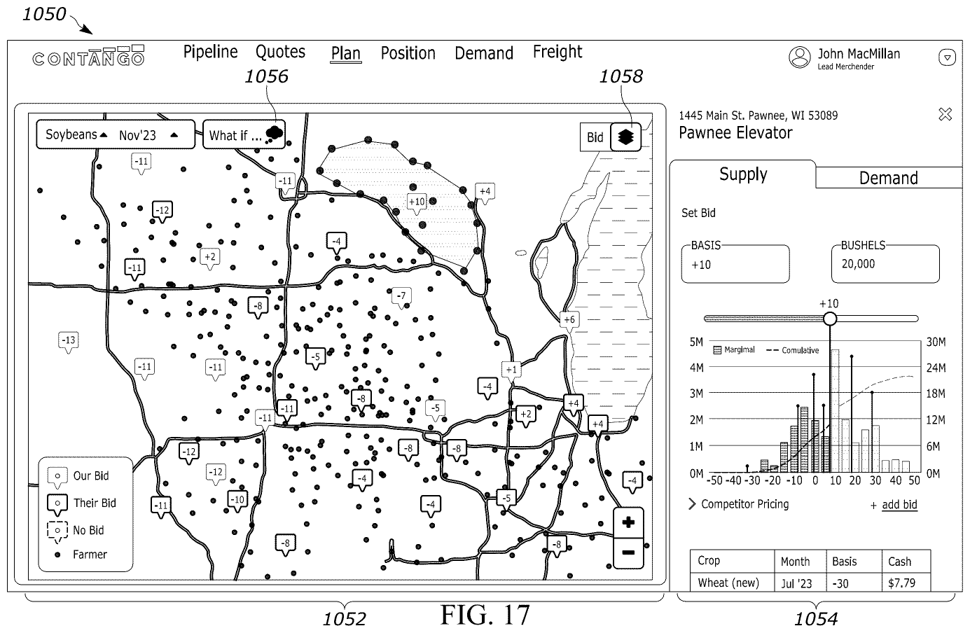

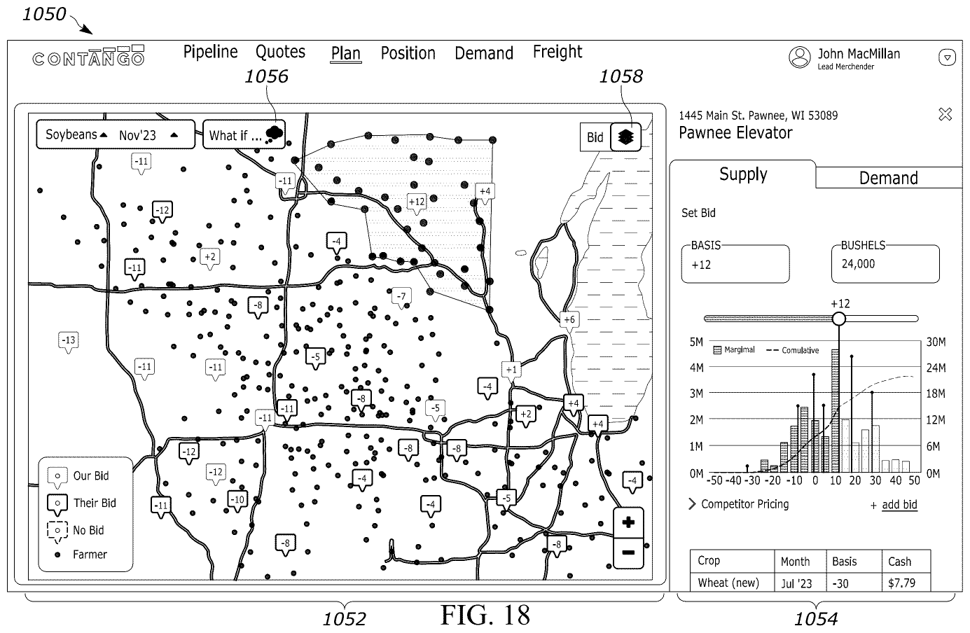

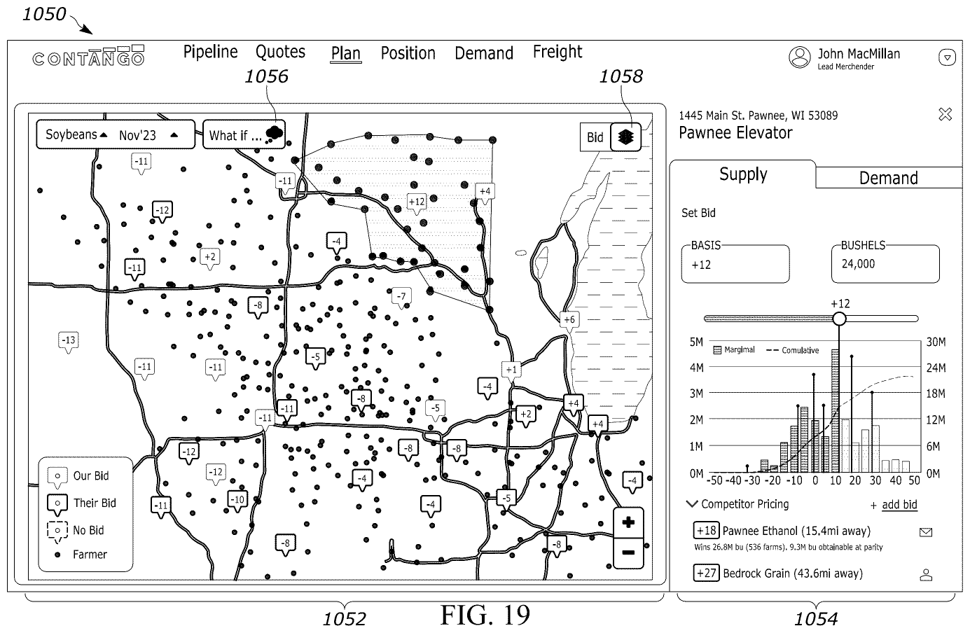

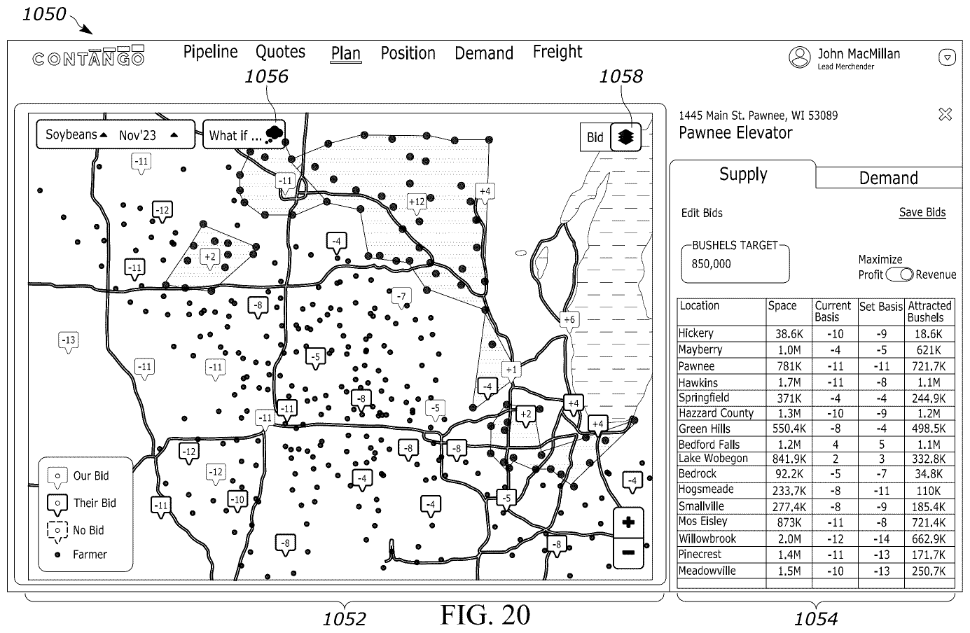

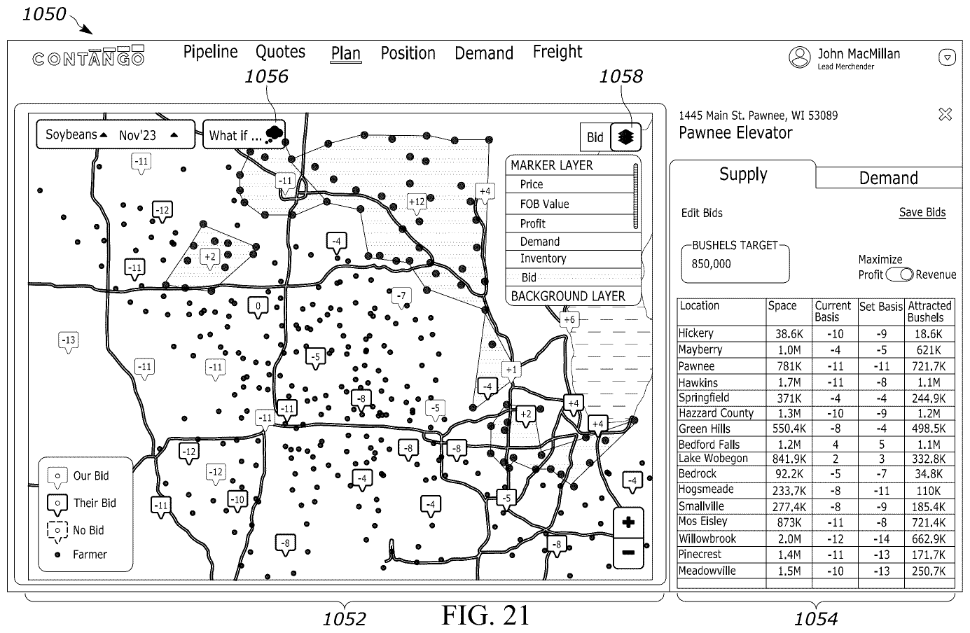

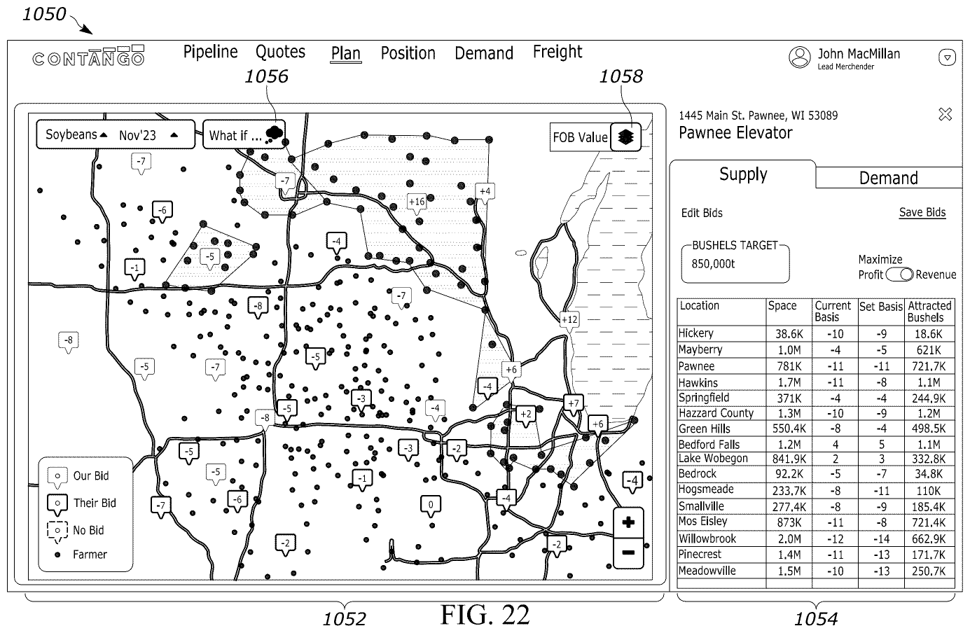

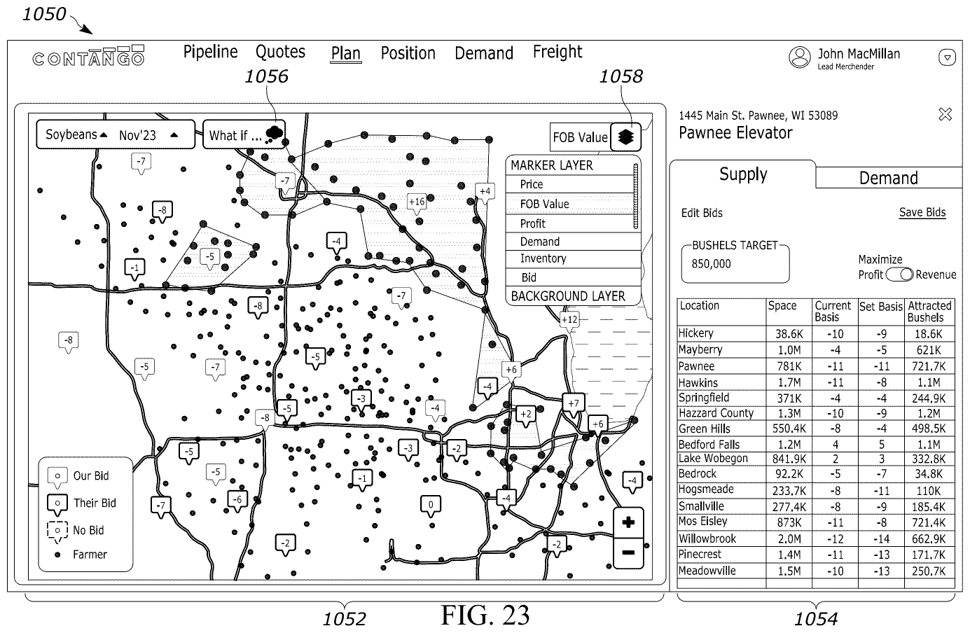

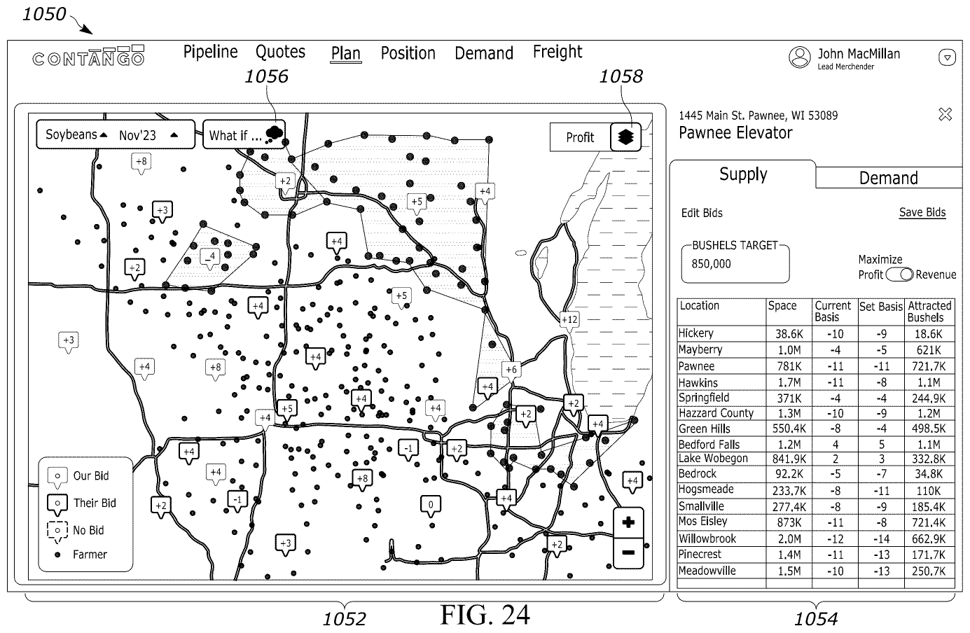

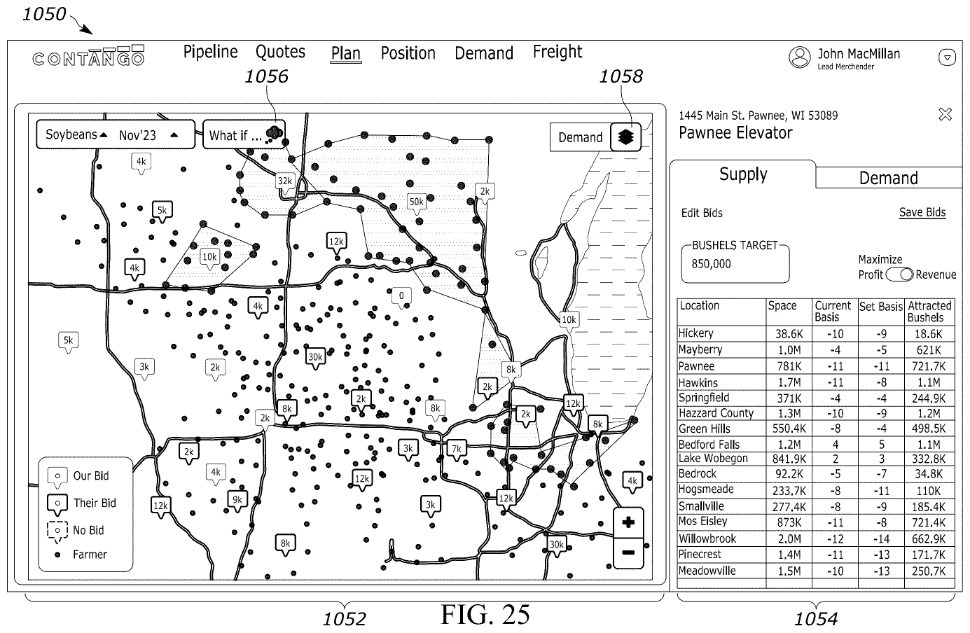

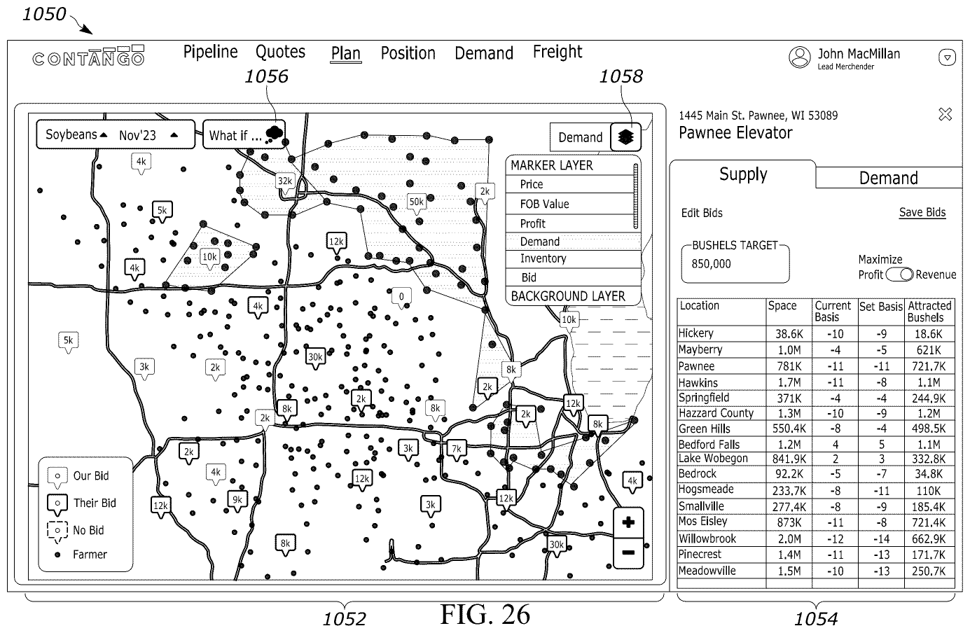

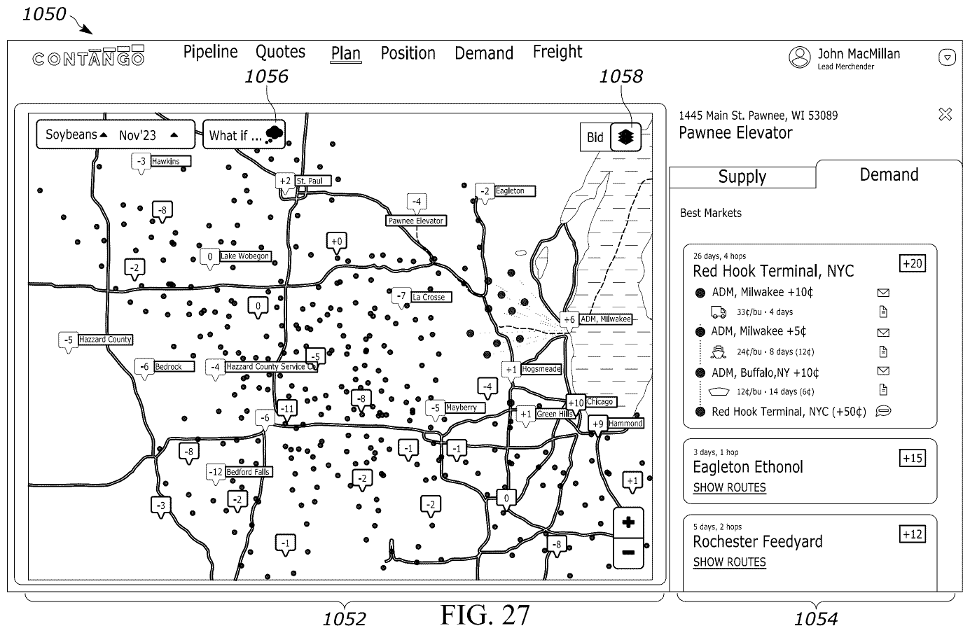

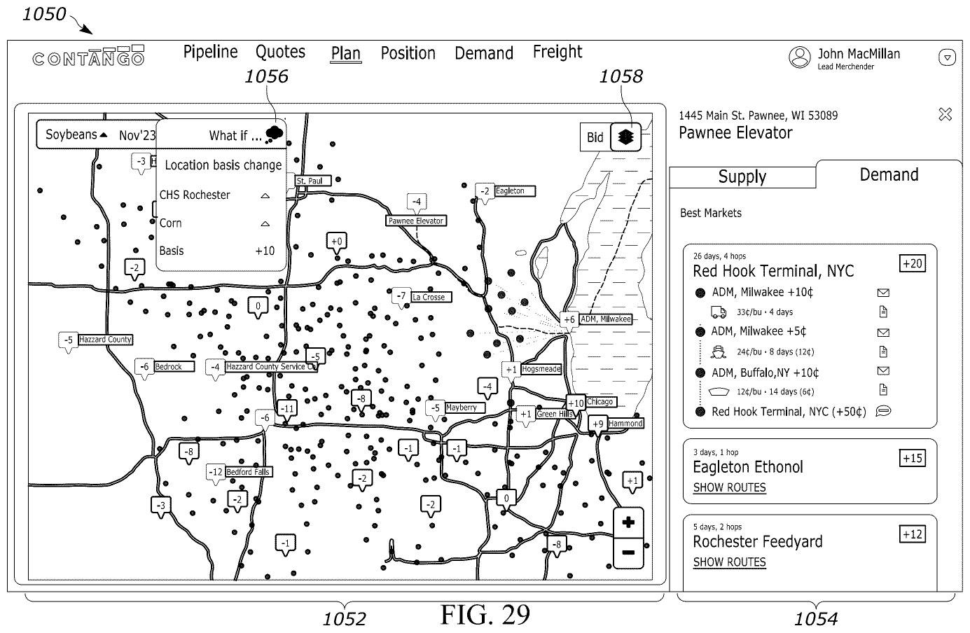

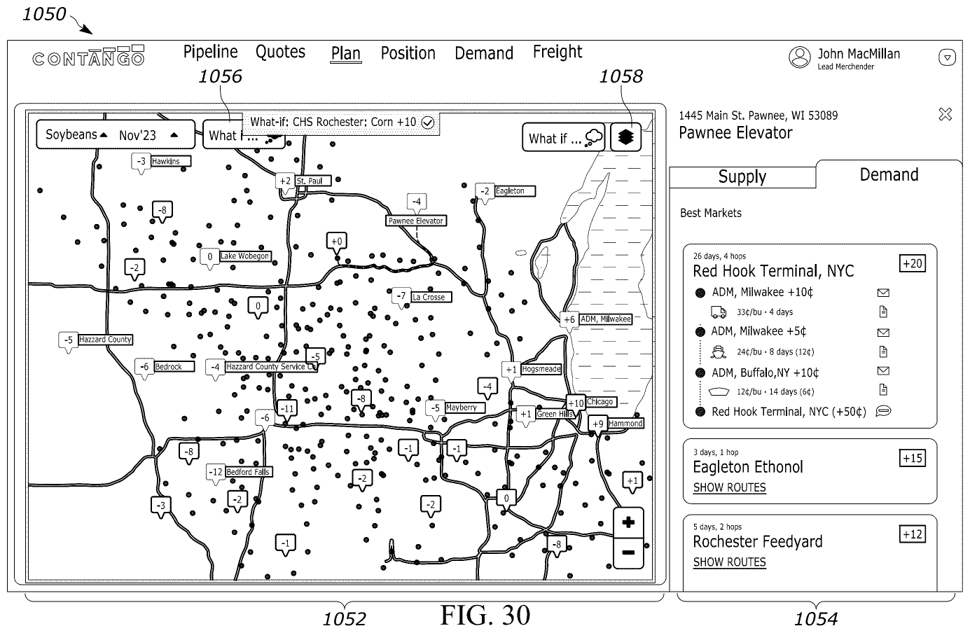

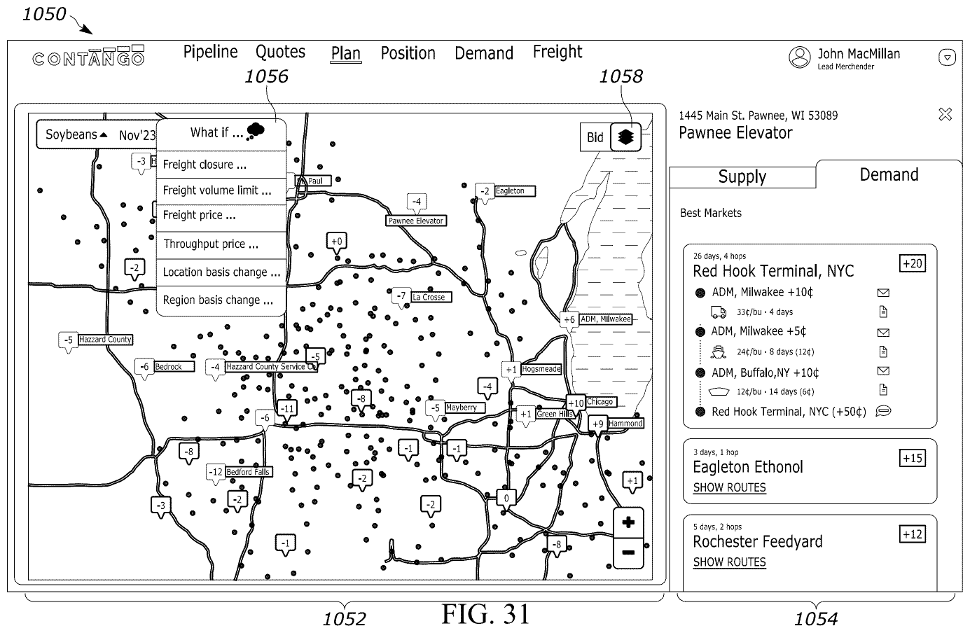

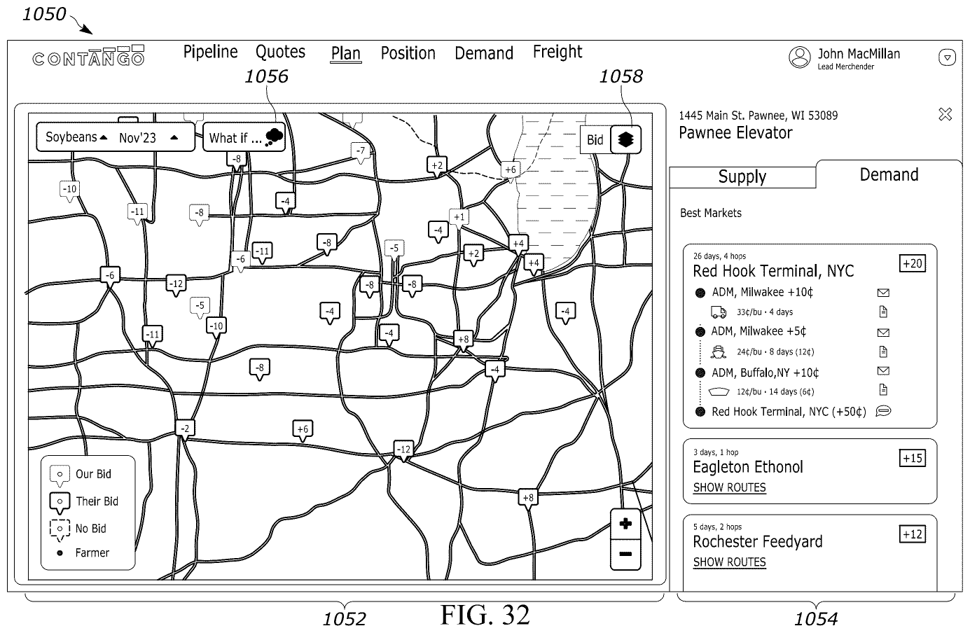

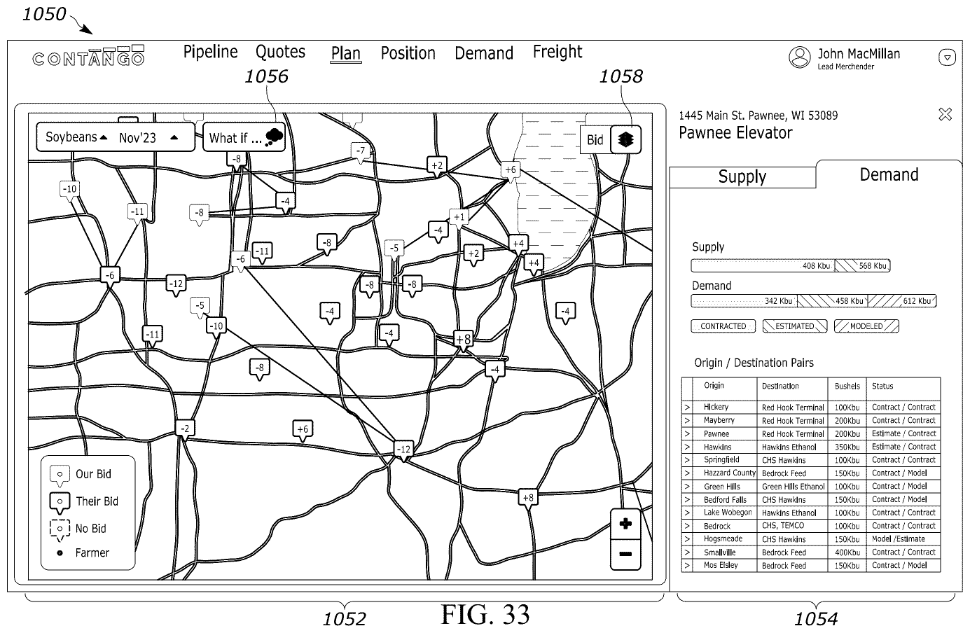

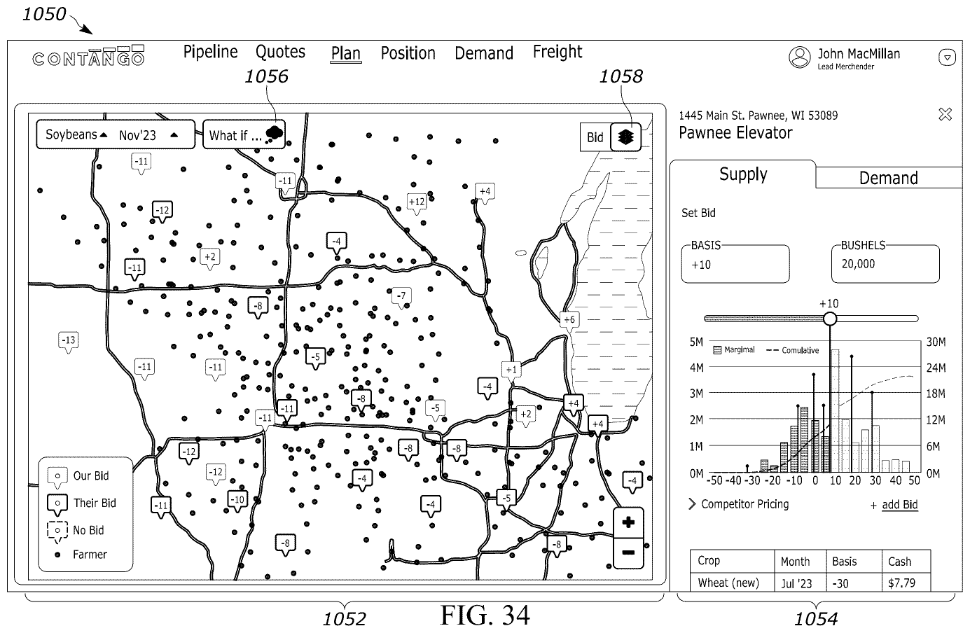

With reference now to FIG. 11, a method for choosing an optimal freight-logical market over time using, for example, the web application (101) and the Best market optimizer (104) is shown. Commodity data can be leveraged to determine the best market over time for a commodity, taking into account freight costs to transport it to each candidate market (700). Market prices are assembled for a given commodity for each delivery period in the future (e.g. each month). Origins will have prices when buying, and destinations will have prices when selling. Transportation costs are also assembled for each origin/destination pair for all available transportation modes (rail, barge, truck, etc) (702). A transportation directional, weighted graph is assembled (see e.g., the screen shots in FIGS. 15-34). Nodes are inserted into the weighted graph representing all origins, destinations, and transfer locations (such as truck to rail). Edges are added to the weighted graph for all transportation links with all relevant cost attributes (e.g. cost, time, throughput, etc) (704). If multiple time periods are being evaluated the weighted graph is replicated for each time period (706). Links are added from each node to the same node in the next time period. The cost is typically the cost-of-carry plus the roll yield. One method for calculating the cost-of-carry is by obtaining the prevailing interest rate (SOFR, LIBOR, etc.) adding additional interest charged by the client's bank, and compounding this until the delivery period. The optimal path is determined using algorithms such as Djikstras, Bellman-Ford, etc. for each possible path (708). Various definitions of optimal are possible including A. least-cost, B. least-time, C. least-cost given time constraint X, D. least time given cost constraint Y, balanced, etc. When selling, product exists at each origin at time 0. Thus the best path from each origin at time 0 to each destination at each time period is calculated to identify the best market and the best time in which to sell. Similarly, when buying, the product should exist at each destination at time period T. The best path is found from each origin at each time period to each destination at time T.

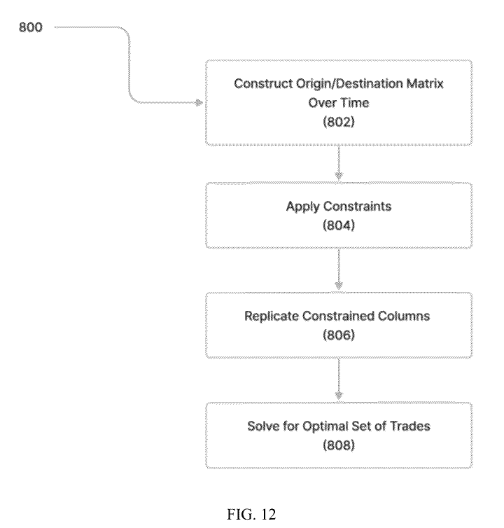

With reference now to FIG. 12, a method for choosing the optimal set of trades while respecting constraints using, for example, the web application (101) and a constrained optimization module (105) is shown. The concept of best markets can be extended to respect constraints. When constraints are imposed, an origin might no longer have a single best market (800). For example, if an origin with best market A contains 5 M bushels of corn and has a signed contract to deliver 1 M bushels to market B then the best set of trades respecting constraints would be 4 M bu. to A and 1 M bu. to B. Perhaps in addition, the rail link connecting the market to A only has the capacity to carry 2 M bu. before the opportunity's delivery window ends, then the best set of trades might be 2 M to location A, 1 M to location B, and the remaining 2 M to some third location C. The optimal set of trades can be computed as follows.

First, the system constructs a cost matrix matching origins to destinations over time (802). When selling, each row of the matrix is an origin [o], and each column is a market at a delivery period [m, p]. If there are M markets and P periods then there will be M×P columns. The value of the cell [o, m, p] is the freight-adjusted market bid from origin [o] to market [m] at period [p]. Similarly, when buying, each row is an origin at period p [o, p] and each destination is a column at time period T by which the product must be available.

Second, the system applies a set of constraints to the matrix using linear programming techniques (804). An illustrated non-exhaustive list of example linear programming techniques includes:
1. Limits to trucking, rail, barge, etc capacity during a time period expressed as a max from origin to a destination in a time period.
2. Previously purchased transportation such as an existing trucking fleet or a rail contract expressed as a minimum from an origin to a destination for a period.
3. Inventory that must be cleared expressed as a minimum at an origin.
4. Existing contracts to markets expressed as a minimum to the market.

Third, all possibilities are included in the matrix through replication (806). In particular, when more than one path exists between an origin and a market, in a period p, then the market/period column is replicated. This replication enables consideration of transportation mode that may be more cost-effective, but that are also constrained. Similarly, when cost tiers exist based on volume or some other factor, they are represented as replicated columns for each price tier with constraints applied.

Finally, the system obtains the optimal set of trades using linear programming methods (808). This list of trades provides several actionable insights including: (i) A list of optimal contracts you should attempt to close. (ii) An estimate of how much of the commodity will need to be moved out of each facility over time. This is useful in determining when to stage trucks, order trains, conditioning grain to be moved by drying or blending, etc. (iii) Estimate the total amount passing over each link in each time period. This allows the user to negotiate larger transportation contracts earlier.

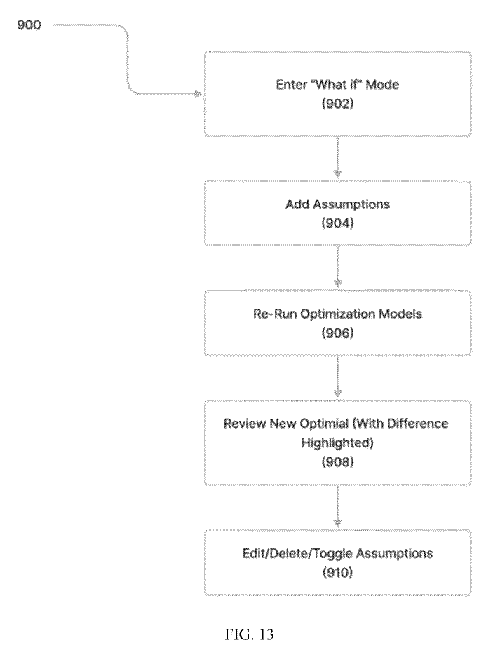

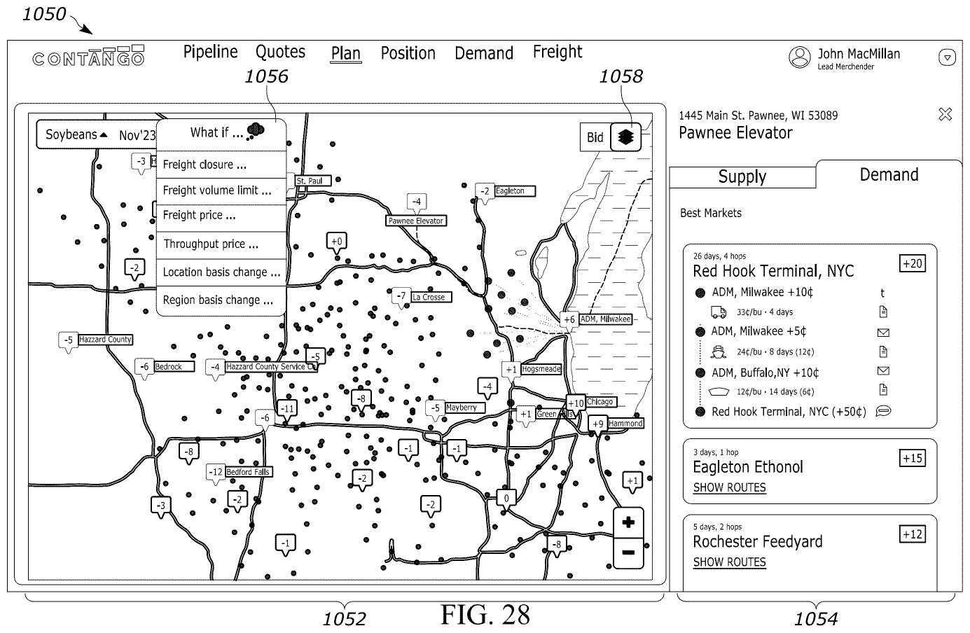

With reference now to FIG. 13, a method for calculating the implications of a market change which has not yet taken place using, for example, the web application (101) and a What-if analysis module (109) is shown. It is often useful to evaluate a scenario that has not yet taken place, but might (900). In such cases, the user can enter a “what if mode” (902) (see also graphical user interface screenshots in FIGS. 28-31). A set of possible changes to evaluate is entered such as “What if location A sells at price $B”, “What if the cost of rail link C reaches $D”, “What if river link E freezes over on date F”, etc (904). Once the assumptions have been recorded, the analysis is re-run taking the assumptions into account (906). These assumptions can be applied to any related analysis output from the sub modules of the web application (101) (e.g., the best market optimizer module (104), the constrained optimization module (105), the storage allocation planning module (106), the price elasticity module (107), the supply and demand estimate module (110), etc.) Assumptions are stored for future analysis and may be deleted or turned on and off in different combinations to simulate possible combinations of real-world changes (908). Concrete examples include:
(I) What if a merchandiser can convince Market X to 10¢ more per bushel? Ru-run the optimization under this assumption. The resulting optimization will answer the questions (A) Is this now the best market for one or more origins (B) Should certain farmers direct-ship to this market?
(II) What if the Union Pacific (UP) goes on strike? In this case, all UP railroad links are removed from the graph, and the global optimization is re-run. The resulting optimization will answer the questions (A) What is plan B for fulfilling my existing contract and (B) How much will plan B cost in time and money?
(III) What if the lower Mississippi water level lowers reducing the tons of grain per load, increasing travel times, and increasing price? Re-run the optimization with the updated price and travel time considerations. (A) Have other modes of transportation such as rail or truck become more cost-effective? (B) Will all contracts continue to be delivered within their delivery windows?

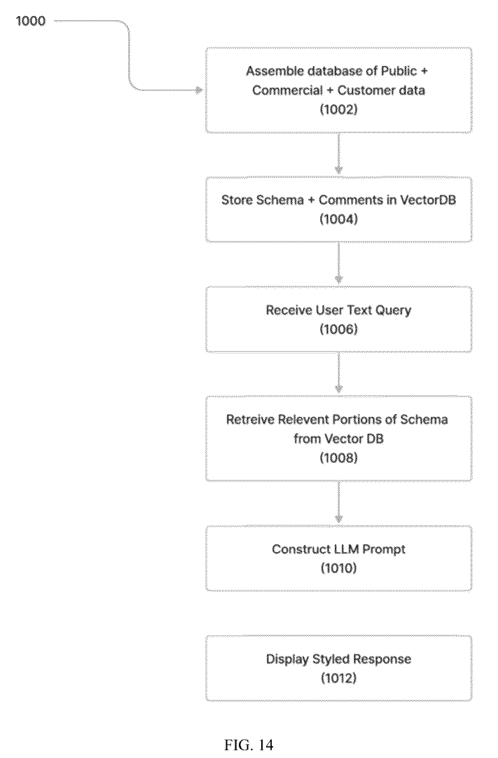

With reference now to FIG. 14, a method for querying structured commodity information using natural language using, for example, the web application (101) and a data chat module (111) is shown. Once these data sets are assembled, complex questions can be asked of the data using natural language (1000). A database is assembled of geo-referenced commodity-related data at the highest spatial resolution available (1002). Market Context Data Sources (140) contains many examples. This data is augmented with optionally time-referenced, optionally geo-referenced customer data including customers, sales, receipts, market share, etc. A schema is constructed of this dataset with descriptions of each data set, table, column, or document format as well as information about how the tables are related. This could be accomplished in a relational database format, a no-SQL format, or some other schema format. Each portion of this schema is stored in a vector database (1004). A user query is received and used to retrieve relevant portions of the schema from the vector database (1006). An LLM prompt is created with (1) the user's query; (2) the retrieved portions of the schema; and (3) an instruction to create a structured query using some query language (e.g. a SQL query, a DuckDB query, a pandas script, etc) (1008). Then the system executes the query against the database, taking appropriate precautions to limit the data that may be queried to what the user should have access to (1010). The results of the query are displayed by optionally augmenting it with visualizations of the response-tables, graphs, etc (1012). The results of the query can also include many records, so, in some embodiments, “displaying” the results can include a link to download the data. Also, if the query question is simple and results in a small amount of data being retrieved, the display can include another call to an LLM to generate a natural language explanation or representation of the results (e.g., an SQL query of “How many farms are above this yield?” that would return a single value can instead invoke an LLM to rephrase the single value into a language explanation: “137 farms are above this yield.”).

With reference now collectively to FIGS. 15-34, screenshots of various iterations of a user interface window 1050 are shown. In general, the user interface window 1050 includes a map section 1052 that displays an interactive map of commodity bid prices and a details section 1054 that displays detailed information relating to the commodity bids as shown in the map section 1052 and/or includes elements for receiving various user inputs as described herein. Furthermore, the user interface window 1050 may include interactive user elements 1056 and 1058 that enables the user to customize and changes the view presented in the map section 1052 and/or the details section 1054.

The various operations of example methods described herein may be performed, at least partially, by the one or more processors described herein that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

What is claimed is:

1. A computing system for generating normalized commodity data from unstructured data sources, inferring missing data items, and optimizing a supply chain based on a structured data set, the computing system comprising:
one or more processors; and
one or more memories storing machine readable instructions that when executed by the one or more processors form a plurality of hardware modules, the plurality of hardware modules comprising:
a structured data extraction module configured to generate normalized commodity data from electronic versions of commodity data hosted on one or more computing systems;
a data inference module configured to generate missing data items in a structured data set using one or more trained inference models; and
an application module configured to save the normalized data and generated missing data items in a data store as part of the structured data set, generate, in response to received user input, supply chain optimization data by inputting a relevant portion of the structured data set into a selected data processing sub-module, and transmit the supply chain optimization data to a client device for presentation on a graphical user interface thereof.

2. The computing system of claim 1 wherein the structured data extraction module is configured to generate the normalized commodity data from electronic versions of commodity data hosted on one or more computing systems by:
interfacing with the one or more computing systems that host the electronic versions of the commodity data;
identifying a format in which the electronic versions of the commodity data are hosted by the one or more computing systems;
extracting the commodity data from the one or more computing systems based on the identified format; and
normalizing the extracted commodity data to conform to preconfigured data formats.

3. The computing system of claim 2 wherein, when the format in which the electronic versions of the commodity data are hosted by the one or more computing systems includes computer readable text data, the structured data extraction module is configured to extract the commodity data from the one or more computing systems by:
identifying whether the computer readable text data is contained in a known format;
parsing the computer readable text data according to preconfigured rules to extract the commodity data when the computer readable text data is contained in the known format; and
extracting the commodity data from the computer readable text data using a trained artificial intelligence language model when the computer readable text data is not contained in the known format.

4. The computing system of claim 1 wherein the data inference module is configured to generate the missing data items in the structured data set using the one or more trained inference models by:
identifying the missing data items from within the structured data set saved in the data store;
identifying the one or more trained inference models that are configured to output the missing data items based on a respective type of each of the missing data items;
identifying input data types for the identified one or more trained inference models;
retrieving current data inputs having respective types that match the identified input data types; and
inputting the current data inputs into the identified one or more trained inference models to generate the missing data items.

5. The computing system of claim 4 wherein the data inference module is configured to train the one or more trained inference models by:
recursively inputting historical data inputs into an initialized inference models, the historical input being data types that correlate with the respective types of the missing data items;
recursively comparing outputs of the initialized inference models to known missing data items generatable from the historical data inputs;
recursively updating the initialized inference models based on a difference between the outputs of the initialized inference models and the known missing data items; and
saving a most recent update to the initialized inference models as the one or more trained inference models when a threshold training criteria is met.

6. The computing system of claim 5 wherein the historical data inputs include one or more of infrastructure data, weather data, agronomic models, agronomic data, and economic data retrieved by the data inference module from electronically accessible market context data sources.

7. The computing system of claim 1 wherein the application module is further configured to generate, in response to the received user input, the supply chain optimization data by:
selecting a data processing sub-module based on received user input;
retrieving a relevant potion of the structured data set from the data store, the relevant potion of the structured data set being based on the received user input and the selected data processing sub-module; and
inputting the relevant portion of the structured data set into the selected data processing sub-module to generate the supply chain optimization data.

8. The computing system of claim 1 wherein the data processing sub-module includes at least one of a best market optimizer module, a constrained optimization module, a storage allocation planning module, a price elasticity optimization module, an infrastructure planning module, a what-if analysis module, a competitor analysis module, and a data chat module.

9. A computer-implemented method comprising:
generating, via one or more processors, normalized commodity data from electronic versions of commodity data hosted on one or more computing systems;
generating, via the one or more processors, missing data items in a structured data set using one or more trained inference models;
saving, via the one or more processors, the normalized data and generated missing data items in a data store as part of the structured data set;
generating, via the one or more processors and in response to received user input, supply chain optimization data by inputting a relevant portion of the structured data set into a selected data processing sub-module; and
transmitting, via the one or more processors, the supply chain optimization data to a client device for presentation on a graphical user interface thereof.

10. The computer-implemented method of claim 9 wherein generating the normalized commodity data from electronic versions of commodity data hosted on one or more computing systems includes:
interfacing, via the one or more processors, with the one or more computing systems that host the electronic versions of the commodity data;
identifying, via the one or more processors, a format in which the electronic versions of the commodity data are hosted by the one or more computing systems;
extracting, via the one or more processors, the commodity data from the one or more computing systems based on the identified format; and
normalizing, via the one or more processors, the extracted commodity data to conform to preconfigured data formats.

11. The computer-implemented method of claim 10 wherein, when the format in which the electronic versions of the commodity data are hosted by the one or more computing systems includes computer readable text data, extracting the commodity data from the one or more computing systems includes:
identifying, via the one or more processors, whether the computer readable text data is contained in a known format;
parsing, via the one or more processors, the computer readable text data according to preconfigured rules to extract the commodity data when the computer readable text data is contained in the known format; and
extracting, via the one or more processors, the commodity data from the computer readable text data using a trained artificial intelligence language model when the computer readable text data is not contained in the known format.

12. The computer-implemented method of claim 9 wherein generating the missing data items in the structured data set using the one or more trained inference models includes:
identifying, via the one or more processors, the missing data items from within the structured data set saved in the data store;
identifying, via the one or more processors, the one or more trained inference models that are configured to output the missing data items based on a respective type of each of the missing data items;
identifying, via the one or more processors, input data types for the identified one or more trained inference models;
retrieving, via the one or more processors, current data inputs having respective types that match the identified input data types; and
inputting, via the one or more processors, the current data inputs into the identified one or more trained inference models to generate the missing data items.

13. The computer-implemented method of claim 12 wherein training the one or more trained inference includes:
recursively, via the one or more processors, inputting historical data inputs into an initialized inference models, the historical input being data types that correlate with the respective types of the missing data items;
recursively, via the one or more processors, comparing outputs of the initialized inference models to known missing data items generatable from the historical data inputs;
recursively, via the one or more processors, updating the initialized inference models based on a difference between the outputs of the initialized inference models and the known missing data items; and
saving, via the one or more processors, a most recent update to the initialized inference models as the one or more trained inference models when a threshold training criteria is met.

14. The computer-implemented method of claim 13 wherein the historical data inputs include one or more of infrastructure data, weather data, agronomic models, agronomic data, and economic data retrieved by the data inference module from electronically accessible market context data sources.

15. The computer-implemented method of claim 9 wherein generating, in response to the received user input, the supply chain optimization includes:
selecting, via the one or more processors, a data processing sub-module based on received user input;
retrieving, via the one or more processors, a relevant potion of the structured data set from the data store, the relevant potion of the structured data set being based on the received user input and the selected data processing sub-module; and
inputting, via the one or more processors, the relevant portion of the structured data set into the selected data processing sub-module to generate the supply chain optimization data.

16. A tangible, non-transitory computer-readable medium storing instructions, that, when executed by one or more processors of a computer system, cause the computer system to:
generate normalized commodity data from electronic versions of commodity data hosted on one or more computing systems;
generate missing data items in a structured data set using one or more trained inference models;
save the normalized data and generated missing data items in a data store as part of the structured data set;
generate, in response to received user input, supply chain optimization data by inputting a relevant portion of the structured data set into a selected data processing sub-module; and
transmit the supply chain optimization data to a client device for presentation on a graphical user interface thereof.

17. The tangible, non-transitory computer-readable medium of claim 16 wherein to generate the normalized commodity data from electronic versions of commodity data hosted on one or more computing systems, the instructions when executed by one or more processors of the computer system, cause the computer system to:
interface with the one or more computing systems that host the electronic versions of the commodity data;
identify a format in which the electronic versions of the commodity data are hosted by the one or more computing systems;
extract the commodity data from the one or more computing systems based on the identified format; and
normalize the extracted commodity data to conform to preconfigured data formats.

18. The tangible, non-transitory computer-readable medium of claim 16 wherein to extracting the commodity data from the one or more computing systems when the format in which the electronic versions of the commodity data are hosted by the one or more computing systems includes computer readable text data, the instructions when executed by one or more processors of the computer system, cause the computer system to:
identify whether the computer readable text data is contained in a known format;
parse the computer readable text data according to preconfigured rules to extract the commodity data when the computer readable text data is contained in the known format; and
extract the commodity data from the computer readable text data using a trained artificial intelligence language model when the computer readable text data is not contained in the known format.

19. The tangible, non-transitory computer-readable medium of claim 16 wherein to generate the missing data items in the structured data set using the one or more trained inference models, the instructions when executed by one or more processors of the computer system, cause the computer system to:
identify the missing data items from within the structured data set saved in the data store;
identify the one or more trained inference models that are configured to output the missing data items based on a respective type of each of the missing data items;
identify input data types for the identified one or more trained inference models;
retrieve current data inputs having respective types that match the identified input data types; and
input the current data inputs into the identified one or more trained inference models to generate the missing data items.

20. The tangible, non-transitory computer-readable medium of claim 16 wherein to generate, in response to the received user input, the supply chain optimization, the instructions when executed by one or more processors of the computer system, cause the computer system to:
select a data processing sub-module based on received user input;
retrieve a relevant potion of the structured data set from the data store, the relevant potion of the structured data set being based on the received user input and the selected data processing sub-module; and
input the relevant portion of the structured data set into the selected data processing sub-module to generate the supply chain optimization data.
